(19) United States
(12) Patent Application Publication
(10) Pub. No.: US 2006/0282326 A1
(43) Pub. Date: Dec. 14, 2006

(54) Network systems and methods for promoting products and services

(75) Inventor: Owen Edward Lombardi, Great Falls, VA (US)

Correspondence Address: LAW OFFICES OF KHALILIAN SIRA, LLC, 9100 PERSIMMON TREE ROAD, POTOMAC, MD, 20854, US

(73) Assignee: Life of Beauty, Inc., Great Falls, VA (US)

(21) Appl. No.: 11/447,428

(22) Filed: Jun. 6, 2006

Related U.S. Application Data
(60) Provisional application No. 60/688,734, filed on Jun. 9, 2005.

(51) Int. Cl. G06Q 30/00

(52) U.S. Cl. 705/14

(57) ABSTRACT

The present invention provides networks and method for promoting specific products and/or services that are associated with an identification system and are uniquely identifiable with a first and a second code. The first code is associated with a charge and the second code is associated with no charge. The ratio of the first code to the second code is at least 2/1.

### CROSS-REFERENCE TO RELATED APPLICATIONS

This application claims benefit of the Provisional Patent Application Ser. No. 60/688,734, filed Jun. 9, 2005, the entire contents of which are hereby incorporated by reference.

### FIELD OF THE INVENTION

The present invention relates to systems and methods for promoting products and services. More particularly, the invention relates to an interactive network and method for commercially benefiting consumers and non-consumers.

### BACKGROUND OF THE INVENTION

The general population is more knowledgeable today about intelligent shopping for products and services they require and the importance in achieving an efficient and economical purchase than ever before and the trend is growing.

The growing interest in the use of the internet for purchase products and services has led to vendors scrambling for new and attractive marketing ploys and advertisements that were not previously considered of critical importance, nor were many vendors formally trained in use of such marketing strategies.

The advent of worldwide computer networks like the internet has allowed many vendors to reach a virtually global consumer base with relatively little cost or effort. Unfortunately, the majority of vendors through the internet, lack the facility or ability to specifically promote a product or a service in accordance with the consumer's ultimate needs.

Consumers, on average, make purchases at least at two retail stores per week and have little time for shopping elsewhere. The various retail stores at which consumers make purchases include, inter alia, outlet stores, shopping centers, hardware stores, grocery stores, drug stores, clothing stores and shoe stores. Consumers often identify items they wish to purchase while going about their daily routines rather than when they are shopping. Thus, vendors implementing systems that motivate consumers to purchase items that are generally useful but not needed by the consumer at the time of purchase, greatly increase their overall revenue stream. These promotion systems, however, have historically worked to the disadvantage of consumers by alluring them to purchase items that were not needed or useful.

Consumers, desire to make purchases with minimal expenditure of effort, time and/or money. What is desirable, however, is a system that while financially benefiting the vendors and the economy as a whole, also works to the advantage of the consumer. It is also desirable for an expanded universe of consumers to reach interactive networks that provides a variety of service providers and stores that benefit the consumer in their daily transactions and purchases by providing special deals. The invention described herein addresses this and other needs by allowing consumers to keep pace with the available products and services, without financial hardship.

### SUMMARY OF THE INVENTION

The invention provides in one aspect a method of promoting a product or a service that is associated with an identification system. Each of the product or service is uniquely identifiable with a first and a second code, wherein the first code is associated with a charge and a second code associated with no charge, and wherein the ratio of the first code to the second code is at least 2/1. The consumer is motivated to purchase the product or the service from a vendor that implements the first code and the second code in order to have chance of obtaining one or more free products or service.

In one embodiment, the identification system comprises universal product bar codes, radio frequency identification tags, biometrics codes, or a combination thereof. In another embodiment, the first code, the second code, or both are electronically scanable barcodes and are designated by the manufacture, vendor, advertisers, or a combination thereof. Vendors comprise, for example, service providers, retailers, wholesalers, dealers, traders, stores, or a combination thereof.

The ratio of the first code to the second code is determined either as a fixed or a variable ratio. The variable ratio is, for example, temporally (e.g., within an hour, daily, monthly, etc), seasonally, or geographically variable (e.g., depending on the location of store).

The ratio of the first code to the second code is in the range of from about 2/1 to about 200/1 or more. In one embodiment, the range of the first code to the second code is from about 6/1 to about 20/1. In another embodiment, the range of the first code to the second code is from about 25/1 to about 50/1. In another embodiment, the range of the first code to the second code is from about 55/1 to about 75/1. In yet another embodiment, the range of the first code to the second code is from about 80/1 to about 200/1 or more. It is intended herein that by recitation of such specified ranges, the ranges recited also include all those specific integer amounts between the recited ranges. For example, in the range of from about 55/1 to about 75/1, it is intended to also encompass 60/1, 65/1, 70/1, etc, without actually reciting each specific range therewith.

In another scope, the invention provides an interactive computerized method of promoting a product or service comprising: a) linking a consumer and a vendor offering the product or services through a central network site, wherein the product or service is associated with an identification system, each of the product or service is uniquely identifiable with a first and a second code, wherein the first code is associated with a price and the second code is associated with no price, wherein the ratio of the first code to the second code is at least 2/1; b) providing a central integration site through which the vendor and the consumer communicate with each other; the central integration site comprising a storage medium having at least a first database, and a second database; c) storing a first database for providing the product or the service associated with the first code; d) storing a second database for providing the product or the service associated with the second code; e)receiving a consumer's request for the product or the service from the central integration site; f) determining whether the product or the service offered to the consumer is associated with the first code or the second code by consulting the first database and the second database; and g) providing to the consumer the product or service associated with the first code or the second code.

In one embodiment, the central integration site consults with a vendor's central point of sale computer prior to selection of the first code or the second code for a product or a service.

In another embodiment, the central network site utilizes the internet.

In yet another embodiment, the central network site utilizes an intranet.

In yet another embodiment, the central network site utilizes an electronic mail.

In another embodiment, a consumer's requests for a product or service is communicated to the central integration site through systems comprising, inter alia, an interactive telephone system, an automatic speech recognition system, a computer keyboard, a telephone keyboard, a pointing device, or any combination thereof.

Other preferred embodiments of the invention will be apparent to one of ordinary skill in the art in light of what is known in the art, in light of the following description of the invention, and in light of the claims.

### DETAILED DESCRIPTION OF THE INVENTION

Definitions

As used herein “network participant” means any entity, including the central integration site, which engages in the access, storage or exchange of products and services on the network.

As used herein, “remote member” means any network participant other than the central integration site. A remote member is either a “consumer remote member” (CRM) or a “non-consumer remote member” (NRM).

The present invention describes network systems and methods for promoting products and services that benefit both consumers and non-consumers. Consumers include, for example, purchasers of a product or a service. Non-consumers include, for example, vendors, product manufacturers, and advertisers, among others. Vendors include, for example, service providers, retailers, wholesalers, dealers, traders, stores, or a combination thereof. Consumers and non-consumers include consumer remote members and non-consumer remote members, respectively.

The product promotion network system and method of the invention provide significant value for each of the consumer and non-consumer groups. For consumers, the product promotion network system of the invention provides an easy and convenient way to obtain and feel assured that they have obtained the best deal possible, while being genuinely excited or elated at the very real possibility of obtaining a free product or service. The product and service promotion network system of the invention provides a great deal of motivation for the consumers to visit vendors, retailers, or suppliers that provide or utilize the promotion network system of the invention in order to enjoy the excitement or elation of receiving a free product or service by chance, without prior knowledge as to what products or services would be free for them at any given time.

The consumers, therefore, would not only be benefited from the financial gains provided to them by vendors that implement the novel methods of marketing and promoting products of the invention, but would also psychologically benefit from the sheer excitement and/or elation of receiving an unexpectedly free product or service. In some respects, the feeling might even approach that felt by gambling but with less negative morality associated with it. Indeed, the expectation of receiving something for free is immensely uplifting for consumers, especially the elderly people, who usually look forward to their daily shopping spree as an eventful part, if not the only part, of their routine daily activity.

Consumers are benefited from the promotional methods of the invention with or without the need for purchasing the products and services provided. Accordingly, in one embodiment, the promotional methods of the invention are provided to consumers that have not purchased the products or services that are being promoted. This system allows for the state-of the art products to reach consumers that have no prior knowledge of the existence of such products. As a result, the promotional methods of the invention have a great impact on commerce and advancement of technology and consumer affairs.

For vendors, the product and service promotion system of the invention offers chance to sell products effectively, e.g., in a manner that maximizes profits while building consumer relationships and market allegiance and/or hype.

For product manufacturers, the product and service promotion system of the invention offers a buying channel where marketing and trade promotion of brands, categories, and relationships can be nurtured in direct relationships with consumers and their shopping lists, while maintaining a great deal of enthusiasm for the consumer.

For advertisers, the product and service promotion system of the invention facilitates communication with those who make important household spending decisions, enabling crafted, precise, messages to be delivered to the right audience in a time efficient manner.

Promotion of any type of a product and/or a service is contemplated within the scope of the invention, so long as they are generally available to the public through the stream of commerce. Products within the scope of the invention, by way of the example and not limitation, include any perishable or a non-perishable goods, such as for example, food, beverage, household products, cosmetics, pharmaceuticals, electrical and electronic goods, automotive, furniture, communication goods, apparel, and farm products, among others.

Services within the scope of the invention, by way of the example and not limitation, include utility services such as, for example, water, phone, gas and electricity, restaurant dining, hotels, health care services, such as for example, dentistry, and medical services, internet services, health clubs membership; membership for profit or non-for profit organizations; banking and credit card services; among others.

The product and service promotion systems of the invention are implanted with any technology that facilitates automatic purchase and sale of product and services, including for example, the Universal Product Code (UPC) Bar Code Technology, Radio Frequency Identification Tag (RFID) technology, biometric technology, or a combination thereof, among others. Alternatively, the product service promotion systems of the invention may be accomplished by simple advertising or selling through an agent or a manufacturer by simple point of sell solicitation and without the use of the Bar Code Technology.

1. Identification Systems

1.1 Universal Product Code (UPC) Bar Code Technology

The methods of promoting products and services of the invention provide for products or services that are uniquely identifiable with a first barcode and a second code, wherein the first code is associated with a charge and a second code associated with no charge. The ratio of the first barcode to the second barcode is in the range of from about 2/1 to about 200/1 or more. In one embodiment, the range of the first barcode to the second barcode is from about 6/1 to about 20/1. In another embodiment, the range of the first barcode to the second barcode is from about 25/1 to about 50/1. In another embodiment, the range of the first barcode to the second barcode is from about 55/1 to about 75/1. In yet another embodiment, the range of the first barcode to the second barcode is from about 80/1 to about 200/1 or more.

In one embodiment, the first barcode, the second barcode or both are barcodes that are electronically scanable. These barcodes are designated by the Universal Product Code, manufacturers, vendors, and/or advertisers, among other groups.

In a preferred embodiment, the first barcode, the second barcode, or both are designated by the Universal Product Code (UPC). UPC bar codes were originally created to help grocery stores speed up the checkout process and keep better track of inventory, but the system quickly spread to all other retail products because it was so successful.

UPCs originate with a company called the Uniform Code Council (UCC). A manufacturer applies to the UCC for permission to enter the UPC system. The manufacturer pays an annual fee for the privilege. In return, the UCC issues the manufacturer a six-digit manufacturer identification number and provides guidelines on how to use it. The manufacturer identification number appears in any standard 12-digit UPC code.

Generally, the UPC symbol printed on a package has two parts: Publishing's manufacturer identification number, which is the first six digits of the UPC number and the item number, which is the next five digits. A UPC coordinator, who is usually employed by a manufacturer, is responsible for assigning item numbers to products, making sure the same code is not used on more than one product, and retiring codes as products are removed from the product line, etc. In general, every item the manufacturer sells, as well as every size package and every repackaging of the item, requires a different item code. For example, a 12-ounce can of Sprite requires a different item number than a 16-ounce bottle of Sprite, as does a 6-pack of 12-ounce cans, a 12-pack, a 24-can case, ext. It is the job of the UPC coordinator to determine a different number for all of these products.

The last digit of the UPC code is called a check digit. This digit lets the scanner determine if it scanned the number correctly or not. There is a mathematical equation to determine a check digit on the basis of the other 11 digits described above. For example, a check digit can be calculated for the code 63938200039 following the example below:
1. Add together the value of all of the digits in odd positions (digits 1, 3, 5, 7, 9 and 11). 6+9+8+0+0+9=32
2. Multiply that number by 3. 32*3=96
3. Add together the value of all of the digits in even positions (digits 2, 4, 6, 8 and 10). 3+3+2+0+3=11
4. Add this sum to the value in step 2. 96+11=107
5. Take the number in Step 4. To create the check digit, determine the number that, when added to the number in step 4, is a multiple of 10. 107+3=110

The check digit for the UPC code 63938200039 is therefore 3.

Each time the scanner scans an item, it performs this calculation. If the check digit it calculates is different from the check digit it reads, the scanner knows that something has gone wrong and the item needs to be rescanned.

The price is determined from the information encoded in a bar code. When the scanner at the checkout line scans a product, the cash register sends the UPC number to the store's central POS (point of sale) computer to look up the UPC number. The central computer sends back the actual price of the item at that moment.

Manufactures have manufacturer IDs with lots of zeros. The short barcodes have zero-suppressed numbers. There is a set of rules around forming zero-suppressed numbers from full numbers, but the basic idea is to leave out a set of four digits, all zeros. The main reason for having zero-suppressed numbers is to create smaller bar codes, for example, on small product packages like 12-ounce cans of coke or sprite.

The first digit of the manufacturer's identification number is special. It is called the number system character. The following table demonstrates different number system characters:

TABLE 1
Designation of UPC standard numbers

| Standard | |
|---|---|
| UPC number | Designation |
| 0 | (must have a zero to form zero-suppressed |
| | numbers) |
| 1 | Reserved |
| 2 | Random-weight items (e.g., fruits, vegetables, |
| | meats, etc.) |
| 3 | Pharmaceuticals |
| 4 | In-store marking for retailers (e.g., a store can |
| | set up its own codes that other store will not |
| | recognize.) |
| 5 | Coupons |
| 6 | Standard UPC number |
| 7 | Standard UPC number |
| 8 | Reserved |
| 9 | Reserved |

The first barcode and/or the second barcode, according to the invention disclosed herein, are designated by UPC, in whole or in part, as explained above. Alternatively, the first barcode and/or the second barcode are designated by the vendor, manufacturers, marketing advertisers, and the like.

In one embodiment, number has been added to or deleted from the first barcode, and/or the second barcode by UPC, the manufacturer, vendor, or advertiser to reflect for price and for no price items.

In another embodiment, the first barcode is designated by the UPC and the second barcode is designated by the manufacturer, the vendor, or the advertiser.

1.2. RFID Tags

In one embodiment, the method of promoting products or services of the invention utilizes the RFID tags (radio frequency identification tags) technology. RFID tags are intelligent bar codes that can talk to a networked system to track every product that a consumer places in her shopping cart. Long checkout lines at the grocery store are one of the biggest complaints about the shopping experience. Soon, these lines could disappear when the ubiquitous Universal Product Code (UPC) bar code is replaced by smart labels, such as RFID tags.

Using RFID tags, consumers can fill up their cart and walk right out of the store without waiting at the check out points. The RFID tags will communicate with an electronic reader that will detect every item in the cart and register each item instantly. The reader will be connected to a large network that will send information on the purchased products to the retailer and product manufacturers. The consumer's bank will then be notified and the amount of the bill will be deducted from the consumer' account.

A ubiquitous network of products and/or services can be purchased using RFID technology. The manufactures and retailers would be able to track smart-labeled products from purchase to trash can. Additionally, the shelves themselves will communicate wirelessly with the network and the tags will be just one component of this large product-tracking network to collect data. The other pieces to this network include the readers that communicate directly with these smart labels and the Internet, which will serve as the communications lines for the network. Readers could soon be expanded to home appliances and gadgets, or could be built directly into the walls of a shopping center building's construction and hence becoming an unseen part of our surroundings.

In one embodiment of the invention, a promotional product such as, for example, water or milk, among myriad of other products, is tagged by an RFID tag that is associated with a no cost or free item, according to the method of promotion of the invention. The product can contain the expiration date and other related information as well as the price or no price indication. When the consumer picks up the product from the shelf, the shelf may display that the product's specific expiration date or price could be wirelessly sent to the consumer's account or personal digital assistant, including for example, cell phones or computers.

The method of the invention assists product manufacturers to know in real time that their product has been purchased, and the quantity of the purchase. Products that a consumer has picked up at the store are automatically tallied as they walk through the doors that have an embedded tag reader. The information from the consumer's purchases is sent directly to their bank, which deducts the amount of the bill from the consumer's account.

In this system, each product will have to be given a unique product number, such as an Electronic Product Code (EPC) identifier that could replace the UPC. Every smart label could contain 96 bits of information, including the product manufacturer, product name and a 40-bit serial number. Using this system, a smart label would communicate with a network, or a database that can retrieve information about a product and then direct information to the manufacturer's computers.

Any ratio of products or services could be associated with a no charge tag according to the manufacturer and/or the retailer specific promotion and marketing strategy. For example the ratio of a charge to a no charge product can be in the range of about 200/1 or more respectively, for example, about 6/1 to about 20/1, about 25/1 to about 50/1, about 55/1 to about 75/1, about 80/1 to about 200/1 or more. A retailer and/or a manufacturer can fix the rate permanently or use the rate in a temporal way (e.g., daily, weakly, monthly, etc.)

1.3. Biometrics Technology

Also encompassed within the scope of the invention is the use of biometric technology in the systems and methods for promoting products and services of the invention. This technology allows automatic identification of a consumer that is purchasing a product or a service of the invention. A manufacturer or a retailer may use biometric technology in accordance with the inventive systems and methods and in compliance with their store strategy and marketing ploys in order to offer the benefits of the promotional methods of the invention to the general public or certain category of the individuals or preferred customers, as the case may be.

Three conventional forms of identification are in use today. The first form is a card, such as a bank card or a credit card. The second form is a password or PIN. The third form is based on the biological characteristics of the consumer. Modern biometric schemes generally rely on sophisticated computer scanning technology, of such aspects of the body and its behavior as the micro-visual pattern on the retina, the geometry of the hand or a finger, the patterns on the surface of the skin of the thumb or fingers, the aural pattern of the voice, the pattern of handwriting or signatures, and facial appearance. In each case, an artifact analyses a sample presented to it, and compares the measurement with a verified sample digitally stored in the system.

Currently the most popular form of biometry is fingerprinting. Reports in the trade press suggest that biometric systems are being developed for a wide spectrum of purposes. Major retail and banking organizations in Australia, Europe and North America are adopting biometric systems for internal security. Blue Cross and Blue Shield in the U.S.A. have plans to introduce nationwide fingerprinting for hospital patients. This may be extended into other medical applications. Tests are being undertaken of the feasibility of storing card-holders' fingerprints on their credit cards, so that a device at the point of purchase can compare the card-borne data with the bearer's fingerprint. This technology is being applied to automated teller machines as well.

In recent years biometric scanners have started becoming popular in many industries including, for example, law enforcement, high security building PC keyboards, insurance companies, etc. Future Consumers may be able to buy a personal fingerprint, hand geometry and/or retina scanner for an affordable price and use it instead of a password or credit card in their normal daily activities.

2. Network Systems

The present invention also provides networks and methods for establishing and operating systems and methods of the invention. The network system of the present invention links CRMs and NRMs such as, for example, vendors, manufactures, advertisers and, and other interested parties around a central integration site (CIS). The CIS is the host of the network system of the present invention into which products and services are listed and shared with consumers. The network system of the present invention thus facilitates the continuous collection, storage and exchange of information regarding products and services that participate in the promotional method of the invention and provides each participant with access to an up-to-date report and a wide pool of knowledge and expertise that can be manipulated to provide a variety of products and services that offer the first barcode and the second barcode system of the invention.

In one embodiment, the central integration site consults with a vendor's central point of sale computer prior to selection of the first barcode or the second barcode for a product or a service.

The network system of the present invention can be implemented in various forms including, but not limited to, a closed intranet having restricted access and resources, or an entry-on-demand network in which the members access the CIS directly via a communications line, such as a telephone link or a wireless link. Preferably, the network system of the present invention is implemented on the Internet. On the Internet, the CIS is addressed at a particular Universal Resource Locator (URL) address. Network participants may access the CIS and enter the network by addressing their Internet browsers to the URL of the CIS.

In one aspect of the invention, one or more sites for NRMs are designed and hosted by the CIS operator, although NRMs may take an active role in placing content on the site for a CRM to find and use. NRMs, such as, for example, vendors, whose product recommendations are solicited by the CRMs, are accessible through a link from the CIS directly to a site provided for the NRMs. NRMs provide information regarding the product and/or services offering the first barcode and the second barcode system of the invention to the CIS, and by extension to CRMs. CRMs can enter the network and access various consumer services or information from the CIS, visits the NRMs through the CIS, and inquires of NRMs for products and/or services that offer the first barcode and the second barcode system of the invention.

Thus, the network system of the present invention serves diverse purposes for its two major member types. For the consumer member, the network system of the present invention provides a source for purchasing products and services. For the non-consumer member, the network system of the present invention provides a source of consumers, a pathway to interact with the customers even when the customers are not present in a physical shop or office. Specific features of the network system services provided to members of the network are presented in the detailed description below.

The CIS coordinates the collection, and subsequent exchange of information among the remote members of the network system of the present invention. The CIS thus comprises the operational elements (e.g., computers, central databases, service processors, central integration sites (CPUs), administrative personnel) necessary to coordinate and administer all activities of the network. The size and complexity of the CIS is directly related to the number of remote members served, or expected to be served, by the network system of the present invention. One of ordinary skill in the art is well aware of the operational elements required to administer a network of given complexity. Preferably, operation and maintenance of a CIS is overseen by one or more network administrators of the network system of the present invention.

In one embodiment, the central integration site consults with a vendor's central point of sale computer prior to selection of the first barcode or the second barcode for a product or a service. Typical POS systems (as used herein POS includes point of sale but also includes point of service) that may be used in the network system of the present invention may include the following components: computers, cash registers/cash drawers, bar code readers/scanners, magnetic card or strip readers, pole displays, receipt printers, electronic scales, modems, keyboards (including keyboards with integrated magnetic strip/card readers and barcode scanner ports), and hand held data collectors (e.g., number pads for inputting credit or debit card personal identification numbers), among others. A POS system may also be modified to enable exchange information with the network. One of ordinary skill in the art is capable of modifying a POS system to exchange information with the network system of the present invention.

Typical POS systems can perform multiple levels of information collection, tracking and storage based on the information directly input by the remote member and information generated through customer purchases. The information collected by the POS system is input to the network, preferably by exchange with the network CIS and it is shared with the network system of the present invention either by direct submission or automatic exchange by remote members with CIS.

In one embodiment, networks systems of the present invention are established and/or promoted by recruiting consumers, for example, by soliciting for network membership. Recruitment also includes the registering a consumer with a service provider, for example, by requesting and recording a consumer's name, e-mail address or other unique identifiers and providing a new consumer account application. Typically, network membership is conditioned upon the submission of information to the network. For consumer network participants, this condition may be fulfilled by providing a unique identifier upon registration. The network sponsors (typically those who administer the network) of the network system of the present invention may offer incentives or consideration for network membership over and above the benefits of network participation. Once the consumer account is established, the consumer may start using the network system of the present invention to purchase the products and services that offer the unique barcode system of the invention.

According to one embodiment, a consultation for a consumer seeking a specific product or a service typically begins with a telephone call or an E-mail to a NRM. The consumer is then asked to provide their shopping request.

Easy access to the information in the network is also made possible by a natural user interface. An interface can be any system or device which allows interaction and information exchange between a remote member and the CIS. For example, domestic and international mail, telephone, telecopier, facsimile, and private and public computerized electronic networks. Preferred interfaces comprise private and public computerized electronic networks, such as, for example, the internet, the wireless web, open networks where the user simply dials in, and dedicated intranets comprising remote users and a central server/data repository. A convenient and most preferred interface is the internet.

Access to the network system of the present invention preferably occurs through a central network website. The central network website allows access to network remote members, either through links to remote member web pages, or by allowing direct communication between remote members (for example, by e-mail). It is understood that the networks of the present invention can be accessed by means other than the internet. For ease of illustration, however, embodiments of the invention will be hereinafter described as being accessible via the internet.

The CRM accesses the network via a CRM interface, for example by typing in the uniform resource locator (URL) for the central network website maintained by the CIS. Typically, network accesses by a CRM are discreet operations, that is, the CRM accesses the network system of the present invention for finite defined periods of time. CRMs generally will not maintain a permanent connection to the network.

Upon access to the network by a CRM, the network system of the present invention displays certain information, for example, general product information, product reviews and recommendations, lists of available services, or any other information chosen by the network administrator for display. Because this information is presented to the CRM upon network access without being specifically requested, this information is termed “unsolicited information.” The unsolicited information is derived from the central database of the CIS, which is a repository of all information possessed by the network, including information provided and/or collected by remote members.

In addition to reviewing the unsolicited information, the CRM can also request a network service. Network service requests are input through the CRM interface, and are submitted to the network service processor. The service processor categorizes the request and executes the appropriate service procedure. The end-result of an executed service is called “service output.” Network services may comprise both informational and transactional services. If the requested service is informational (e.g., request to locate a certain product that offer the first and second barcode system of the invention and or request to view a database), the service processor accesses the CIS central database for the desired information and forwards the information through the service output to the CRM. If the requested service is transactional (e.g., request for purchase of a specific product and/or service) the service processor performs the necessary actions to effect the desired transaction and displays the result or informs the CRM that the transaction has been completed.

The NRM collects information relating to the consumer's request through the network system of the present invention. The NRM accesses the network through a non-consumer remote interface, for example by connecting to the central network website via the internet, and inputs this information to the CIS central database. The CIS organizes and stores this information in the central database. Information submission by the NRM can be on a regular basis (e.g., regular submission of a consumer's requests at defined intervals).

The development of on-line computerized electronic networks greatly facilitates construction, maintenance and operation of the network systems of the present invention. However, it is understood that the present networks and methods of the present invention are not limited to computerized electronic networks. Network systems of the present invention can be created and maintained through any system of information exchange and storage.

The network system of the present invention further comprises exchange means through which remote members interact with the network and exchange information with the CIS. As described above, the interface comprises any means for interacting with the CIS, but preferably comprises a computerized electronic network such as the Internet.

The network of the invention provides variety of services including, for example, administrative services, services related to remote purchase and/or sale of specific products and/or services, generating consumer's bills, requesting specific product and/or service information from vendors that offer the barcode systems of the invention, mediating interaction between the consumer and the vendors, mediating interaction between the consumer and other employees and management of NRMs including administrators of the network, and with other consumers. Such interaction can include, for example, the creation or maintenance of consumer groups (e.g., general interest groups, product use groups), message posting services (e.g., “chat rooms” or bulletin boards), and direct consumer-to-consumer communication (e.g., e-mail).

Administrative functions of the network system of the present invention include, for example, collecting and storing network information, managing the content, organization and presentation of information on the network, maintaining network interfaces, recruiting network members and fulfilling request for information or network services.

Also contemplated within the scope of the invention is the physical product distribution through shipping and handling system. A server system (herein called a Sales Support Server) integrates the collection of a payment via the network system of the present invention and the automatic distribution of the product with the calculation of commissions using a multi-level marketing commission structure and the distribution of commissions and fees via the network. The preferred configuration includes a client application (herein called a Sales Application) which runs as a plug-in to a network browser on the customer's computer and which provides a purchase request and registration data to a Sales Support Server and performs the installation of the product on the customer's computer. The Sales Support Server acquires the payment, transfers the product, calculates and pays the commissions, and adds the purchaser's registration information to the multi-level sales database for the product. Consumers may pay for product through systems such as, for example, I-mode Felica (e.g., mobile phone wallets), among others

One skilled in the art will readily appreciate that the present invention is well adapted to carry out the objects and obtain the ends and advantages mentioned, as well as those inherent therein. The present invention may be embodied in other specific forms without departing from the spirit or essential attributes thereof and, accordingly, reference should be made to the appended claims, rather than to the foregoing specification, as indicating the scope of the invention.

What is claimed is:

1. A method of promoting a product or a service associated with an identification system, each of the product or service is uniquely identifiable with a first and a second code, wherein the first code is associated with a charge and a second code associated with no charge, and wherein the ratio of the first code to the second code is at least 2/1, and wherein a consumer is motivated to purchase the product or the service from a vendor that implements the first code and the second code in order to have chance of obtaining one or more free products or service.

2. The method of claim 1, wherein the identification system comprises universal product bar codes, radio frequency identification tags, biometrics codes, or a combination thereof.

3. The method of claim 1, wherein the first code, the second code, or both are electronically scanable barcodes.

4. The method of claim 2, wherein the first barcode, the second barcode, or both are designated by the manufacture, vendor, advertisers, or a combination thereof.

5. The method of claim 4, wherein the vendor comprises service providers, retailers, wholesalers, dealers, traders, stores, or a combination thereof.

6. The method of claim 1, wherein the ratio of the first code to the second code is at least about 5/1

7. The method of claim 1, wherein the ratio of the first code to the second code is at least about 10/1

8. The method of claim 1, wherein the ratio of the first code to the second code is at least 20/1

9. The method of claim 1, wherein the ratio of the first code to the second code is at least about 30/1

10. The method of claim 1, wherein the ratio of the first code to the second code is at least about 40/1

11. The method of claim 1, wherein the ratio of the first code to the second code is at least about 50/1 or more.

12. The method of claim 1, wherein the ratio of the first code to the second code is fixed or variable.

13. The method of claim 1, wherein the ratio of the first code to the second code is temporally variable, geographically variable, seasonally variable, or a combination thereof.

14. An interactive computerized method of promoting a product or service comprising:
a) linking a consumer and a vendor offering the product or services through a central network site, wherein the product or service is associated with an identification system, each of the product or service is uniquely identifiable with a first and a second code, wherein the first code is associated with a price and the second code is associated with no price, wherein the ratio of the first code to the second code is at least 2/1;
b) providing a central integration site through which the vendor and the consumer communicate with each other; the central integration site comprising a storage medium having at least a first database, and a second database;
c) storing a first database for providing the product or the service associated with the first code;
d) storing a second database for providing the product or the service associated with the second code;
e) receiving a consumer's request for the product or the service from the central integration site;
f) determining whether the product or the service offered to the consumer is associated with the first code or the second code by consulting the first database and the second database; and
g) providing to the consumer the product or service associated with the first code or the second code.

15. The method of claim 14, wherein the central integration site consults with a vendor's central point of sale computer prior to selection of the first code or the second code for a product or a service.

16. The interactive computerized method of claim 15, wherein the central network site utilizes the Internet, an intranet, or both.

17. The interactive computerized method of claim 14, wherein the consumer requests for a product or service is communicated to the central integration site through systems comprising an interactive telephone system, an automatic speech recognition system, a computer keyboard, a telephone keyboard, a pointing device, or any combination thereof.

18. The method of claim 14, wherein the first code, the second code, or both are electronically scanable barcodes.

19. The method of claim 14, wherein the central integration site consults with a vendor's central point of sale computer prior to selection of the first code or the second code for a product or a service.

20. The method of claim 14, wherein the ratio of the first code to the second code is fixed or variable.
